(19) United States
(12) Patent Application Publication
(10) Pub. No.: US 2014/0046810 A1
(43) Pub. Date: Feb. 13, 2014

(54) Systems and Method of Managing a Pool of Items

(71) Applicant: LE GROUP OF COMPANIES LIMITED, Hong Kong (HK)

(72) Inventor: Henry Guy Stevens, London (GB)

(73) Assignee: LE GROUP OF COMPANIES LIMITED, Hong Kong (CN)

(21) Appl. No.: 13/833,422

(22) Filed: Mar. 15, 2013

(30) Foreign Application Priority Data
Aug. 9, 2012 (GB) GB1214272.5

(51) Int. Cl. G06Q 10/08; G06Q 30/04

(52) U.S. Cl. CPC G06Q 10/087; G06Q 30/04
USPC 705/28

(57) ABSTRACT

In some aspects, the invention provides a data processing system configured to provide distributed management of a pool of pallets from pallet introducers, each pallet including an identification tag including electronically stored identification information, the system comprising:
an input interface for receiving data relating to an identification tag read at a plurality of locations;
a database adapted to store, for each pallet of the pool of pallets, a record comprising data read from the identification tag, tracking data identifying the location of the pallet, pallet activity data and pallet introducer data;
an interface for receiving identifiers of pallets introduced by an introducer;
an interface for a pallet user receiving or dispatching a pallet to upload identifiers of pallets received or dispatched;
logic to monitor events relating to a pallet for actionable or chargeable events;
logic to credit an account related to the introducer of a pallet for a chargeable event.

### CROSS-REFERENCE TO RELATED APPLICATION

This application claims priority to GB Patent Application No. GB 1214272.5, filed on Aug. 9, 2012, which is incorporated by reference in its entirety.

### BACKGROUND

1. Field of the Invention

The present invention provides novel systems and methods which enable multiple introducers of pallets and other items to manage supplied items effectively.

2. Description of the Related Art

There are two main models for managing large inventories of items, such as pallets.

In the first model, the large inventory has a single owner. Owners of large inventories of items of manufacture, such as pallets, usually get an income from renting their items. In the case of item rental, the owners usually use distribution tracking systems, in order to be able to control and track their items. Conventional tracking systems are configured to control and track the items shipped from place to place, and they may be provided by third party companies specialized in large inventories tracking Ownership of the pallets is not modified during the life of the pallets.

In the second model, ownership of the pallet is transferred from user to user, and the price of the pallets is included in the price of the palletized products.

In the first model, ownership is maintained and only the owner of the pallets may get an income. This model does not promote cooperation of the different operators in a use cycle. Valuable distribution tracking systems are not shared between economically independent entities and there is a significant prejudice against sharing. Furthermore the first model allows return of the pallets to a limited number of places for a return to the owner of the pallets. Conventional distribution tracking systems thus usually require the items to travel significant distances for maintenance, back to the premises of the owner from the customers, which generates an economic and environmental waste by increasing fuel consumption and release of greenhouse effect exhausts in the atmosphere.

In the second model, the pallets tend to be discarded, and they often go to waste. This thus generates an economic and environmental waste.

Conventional distribution tracking systems have not maximized the potential for providing an economically efficient solution, and the owners usually have to pay a significant amount of money per item for usage of the conventional distribution tracking systems. This can be problematic to owners who would like to get an income from rental of their items, but who cannot afford a conventional distribution tracking system, e.g., when the cost of tracking per item represents too great a proportion of the cost of the item, e.g., for a wooden, cardboard or polystyrene pallet.

### SUMMARY

The foregoing often means that distribution tracking systems are usually only implemented on plastic pallets, because plastic pallets, as compared to traditional wooden pallets, are sturdier, readily washable and more easily maintained, and as a consequence the useful life of the pallet may be greatly increased. Therefore a huge number of already existing wooden, cardboard or polystyrene pallets are not tracked or maintained at all, which generates an economic and environmental waste.

Embodiments of the present disclosure aim to ameliorate at least one of the above issues.

In some aspects in accordance with the disclosure, there is provided a data processing system configured to provide distributed management of a pool of pallets from pallet introducers, each pallet including an identification tag including electronically stored identification information, the system comprising:

an input interface for receiving data relating to an identification tag read at a plurality of locations;

a database adapted to store, for each pallet of the pool of pallets, a record comprising data read from the identification tag, tracking data identifying the location of the pallet, pallet activity data and pallet introducer data;

an interface for receiving identifiers of pallets introduced by an introducer;

an interface for a pallet user receiving or dispatching a pallet to upload identifiers of pallets received or dispatched;

logic to monitor events relating to a pallet for actionable or chargeable events;

logic to credit an account related to the introducer of a pallet for a chargeable event.

The database may further be adapted to store, for each introducer, an agreed tariff for introducing a pallet in the pool.

In the specification, it is appreciated that all the tariffs may be different for different introducers, repairers, storage facilities, manufacturers, etc. In the specification, it is also appreciated that all the tariffs may be different for different types of pallets.

The database may further be adapted to store, for each introducer, an agreed tariff for a pallet activity. The pallet activity data may identify an activity selected from the group consisting of: registration; use by a customer; loss by a customer; transport for the customers or manager; storage for the manager; manufacture; repair; a combination thereof.

The system may further comprise logic to credit an account related to the introducer of a pallet based on at least one of an average activity or an aggregate activity of the pallets. The management is thus easier, as the activity of the pallets may be averaged over a predetermined period, such as a month, a quarter or a year. The activity may be aggregated over periods such as a month, a quarter or a year. The introducer may then be credited on the actual activity (such as rent by customers) or an average activity of his pallets, and/or get a proportion of the aggregate activity of the pallets of the pool in general, so that he might then get an income even e.g., if his pallets are not used as much as the other introducers. The credit received by the introducer may also be based on an owned proportion of the pool. For instance, if the introducer introduced 100 000 pallets in a pool of a million pallets, he might get an income of e.g., 10% of the income shared between the introducers.

The credit may be paid to the introducer e.g., monthly, quarterly, annually, as agreed with the manager.

In embodiments, the system may further comprise logic to credit an account related to the introducer of a pallet based, for each pallet, on a predetermined proportion of the income generated by the pallet over a predetermined time interval, such as a percentage of an income generated by the pallet for the life of the pallet.

The system may further comprise logic to credit an account related to the introducer of a pallet based on a pallet activity selected from the group consisting of delivery and collection of a pallet, based on the agreed tariff. As already explained, the introducer may then be credited for transporting the pallets on behalf of the manager.

The system may further comprise logic to credit an account related to the introducer of a pallet based on a repair of a pallet, based on the agreed tariff.

The chargeable event may also comprise loss. The introducer is thus encouraged to introduce the pallet in the pool, because he will get an income, even if his pallets are lost by the customers.

In embodiments, the system may further comprise: an interface for a transporter of pallets to upload identifiers of pallets in transit; and logic to credit an account related to the transporter of the pallet for a chargeable event. The chargeable event may further comprise a trip.

In embodiments, the system may further comprise: an interface for a storage facility to upload identifiers of pallets for storage; and logic to credit an account related to the storage facility for a chargeable event. The chargeable event may further comprise storage.

In embodiments, the system may further comprise: an interface for a maintainer of pallets to upload data relating to a maintenance activity; and logic to credit an account related to the maintainer for a chargeable event. The chargeable event may further comprise at least one of: repair and storage.

An example of an advantage provided by the invention is that an operator in the use cycle of the item, such as a manufacturer, a maintainer, a keeper, or a transporter of the pallets may get an income even if he does not have ownership of the pallets and regardless of the introducer of the pallet in the pool.

In some embodiments, the invention allows an operator to get an income for a chargeable event recorded by the manager of the pool but performed by a third party.

In some embodiments, the information stored in the database may further comprise information selected from the group consisting of: pallet rental order; new pallet manufacture order; equipment and spare parts order; equipment and spare parts delivery confirmation; raw material order; raw material delivery confirmation; new pallet supply confirmation; registration of pallet to the common pool; number of pallets in stock; pallet delivery notification; pallet collection notification; pallet repair confirmation; pallet general condition information; confirmation of pallet for scrap; income from pallet customer; payment to pallet activity operator; information feedback; technical query; technical response; a combination thereof

The pallet is selected from the group consisting of: a plastic pallet, a wooden pallet, a cardboard pallet, a polystyrene pallet, and a plastic coated pallet selected from the group consisting of wooden; cardboard; polystyrene pallet.

In another aspect of embodiments in accordance with the disclosure, there is provided a system configured to provide a unified management of a pool of pallets from multiple owners for rent by customers, each pallet including an identification tag including electronically stored identification information, comprising a network connecting platforms of:

a manager of the pool of pallets,

a plurality of manufacturers of the pallets,

a plurality of repairers of the pallets, and

a plurality of keepers for storage of the pallets, the system being further configured to enable identification of a need for:

a request for manufacture of a new pallet to replace a missing pallet from the pool or to meet rent requests by customers;

a repair request to repair a pallet no longer satisfactory for rent; and

a storage request to store a pallet no longer required by the manager to meet rent requests by customers.

The system may further be configured to identify a proximate operator for an activity selected from the group consisting of: manufacture; a repair; storage; a combination thereof. This might allow reduction of the distance travelled by empty pallets and therefore reduce economic and environment waste.

The system may further adapted to store information selected from the group consisting of: pallet rental order; new pallet manufacture order; equipment and spare parts order; equipment and spare parts delivery confirmation; raw material order; raw material delivery confirmation; new pallet supply confirmation; registration of pallet to the common pool; number of pallets in stock; pallet delivery notification; pallet collection notification; pallet repair confirmation; pallet general condition information; confirmation of pallet for scrap; income from pallet customer; payment to pallet activity operator; information feedback; technical query; technical response; a combination thereof.

In another aspect of embodiments in accordance with the disclosure, there is provided a method comprising:

providing an input interface for receiving data relating to an identification tag including electronically stored identification information read at a plurality of locations, the identification tag being included in a pallet of a pool of pallets from pallet introducers;

storing in a database, for each pallet of the pool of pallets, a record comprising data read from the identification tag, tracking data identifying the location of the pallet, pallet activity data and pallet introducer data;

providing an interface for receiving identifiers of pallets introduced by an introducer;

providing an interface for a pallet user receiving or dispatching a pallet to upload identifiers of pallets received or dispatched;

monitoring events relating to a pallet for actionable or chargeable events;

crediting an account related to the introducer of a pallet for a chargeable event.

The chargeable event is selected from the group consisting of: use; loss; storage; a combination thereof.

The method may further comprise: providing an interface for a transporter of pallets to upload identifiers of pallets in transit; and crediting an account related to the transporter of the pallet for a chargeable event. The chargeable event may further comprise at least one of: trip and storage.

The method may further comprise: providing an interface for a maintainer of pallets to upload data relating to a maintenance activity; and crediting an account related to the maintainer for a chargeable event. The chargeable event may further comprise at least one of: repair and storage.

The pallet activity data may identify an activity selected from the group consisting of: registration; use; loss; transport; storage; manufacture; repair; a combination thereof.

The method may further comprise storing, for each introducer, an agreed tariff for introducing a pallet in the pool, or storing, for each introducer, an agreed tariff for a pallet activity.

The method may further comprise crediting an account related to the introducer of a pallet based on a pallet activity selected from the group consisting of delivery and collection of a pallet, based on the agreed tariff.

The method may further comprise crediting an account related to the introducer of a pallet based on a repair of a pallet, based on the agreed tariff.

The method may further comprise crediting an account related to the introducer of a pallet based on at least one of an average activity or an aggregate activity of the pallet.

The method may further comprise crediting an account related to the introducer of a pallet based on a percentage of an income for the life of a pallet.

In another aspect of embodiments in accordance with the disclosure, there is provided a method comprising:

identifying pallets of a pool, each pallet including an identification tag including electronically stored identification information; and

storing, for each pallet of the pool of pallets, a record comprising data read from the identification tag, tracking data identifying the location of the pallet, pallet activity data and pallet introducer data; and

storing financial information data based on the data comprised in the record and enabling distribution of funds between operators based on the activity of the pallet.

In another aspect of embodiments in accordance with the disclosure, there is provided a method comprising:

tracking the pallets of the pool as a function of the location of the pallets,

selecting the pallets for distribution to another location corresponding to at least one of a customer and an operator, in order to meet the orders from the clients and maintaining a condition of the pallets of the common pool above a predetermined threshold, respectively; and

ordering manufacture of new pallets to manufacturers, in order to maintain the number of pallets in the common pool above a predetermined threshold.

The method may further comprise determining an income from a customer to a pallet pool manager, based on the orders from the customer.

The method may further comprise determining a payment from the pallet pool manager to an owner of the pallets, based on a number of pallets from the owner in the common pool.

The method may further comprise determining a payment from the pallet pool manager to an operator of an activity on the pallets, based on at least one of storage, repair and manufacture.

The method may further comprise determining a shipment history of the pallets as a function of at least one of (a) previously scanned information and (b) previous scanning location information previously stored in the database.

The method may further comprise classifying a transaction as one of (a) a return and (b) a transfer based on at least one of (a) a most recent scanning location in the shipping history and (b) a duration of time between successive scans of the pallet.

Further features and aspects of example embodiments of the present disclosure are described in more detail below with reference to the appended Figures.

### BRIEF DESCRIPTION OF THE DRAWINGS

FIG. 1 schematically illustrates an exemplary system for tracking and managing items, e.g., pallets, which may be used in connection with the method described herein;

FIG. 2 schematically illustrates an exemplary data flowchart, e.g., in a pooled pallet system, which may be used in connection with the method and system described herein;

FIG. 3 schematically illustrates an exemplary data flowchart, e.g., between a central database and a manager of the common pool of items, which may be used in connection with the method and system described herein;

FIG. 4 schematically illustrates an exemplary data flowchart, e.g., between a central database and a repairer or storage facility or a manufacturer of the items of the common pool, e.g., an authorized pallet manufacturer, which may be used in connection with the method and system described herein;

FIG. 5 schematically illustrates an exemplary data flowchart, e.g., between a central database and a production technology provider, which may be used in connection with the method and system described herein;

FIG. 6 schematically illustrates an exemplary item, e.g., a pallet, which may be used in connection with the method and system described herein;

FIG. 7 is a flow diagram of a method according to an example embodiment of the present invention;

FIG. 8 is a top view of a pallet suitable for processing in accordance with the disclosure;

FIG. 9 is an underneath perspective view of the pallet of FIG. 8;

FIGS. 10, 11 and 12 together show a flow diagram showing the components in a process for producing a pallet according to one embodiment the disclosure.

In the Figures like reference numerals are used to indicate like elements.

### DETAILED DESCRIPTION

Example embodiments of the present invention provide a method for managing a pool of items, e.g., pallets, each item being embedded with an identification tag storing electrically stored identification information. The managing method is performed in a manner that may decrease distances travelled by the items, whilst increasing control over the distribution and improving maintenance of the pool, and whilst optimizing income both for the items owners and the pool manager, and whilst optimizing payments for the customers of the items.

The method described herein is particularly applicable to the field of pallet pooling, which provides the ability for customers to rent to a pool manager an exact number of pallets needed, rather than stocking sufficient pallets for, e.g., peak seasons, whilst allowing excess pallets to remain in storage during off-peak seasons. In a pallet pooling system, customers (such as manufactures of products, distributors, retailers, etc.) rent rather than own the pallets. The pallets are owned by, e.g., the pallet owner. As explained in greater detail below, the pallet owner may or may not be also the pool manager.

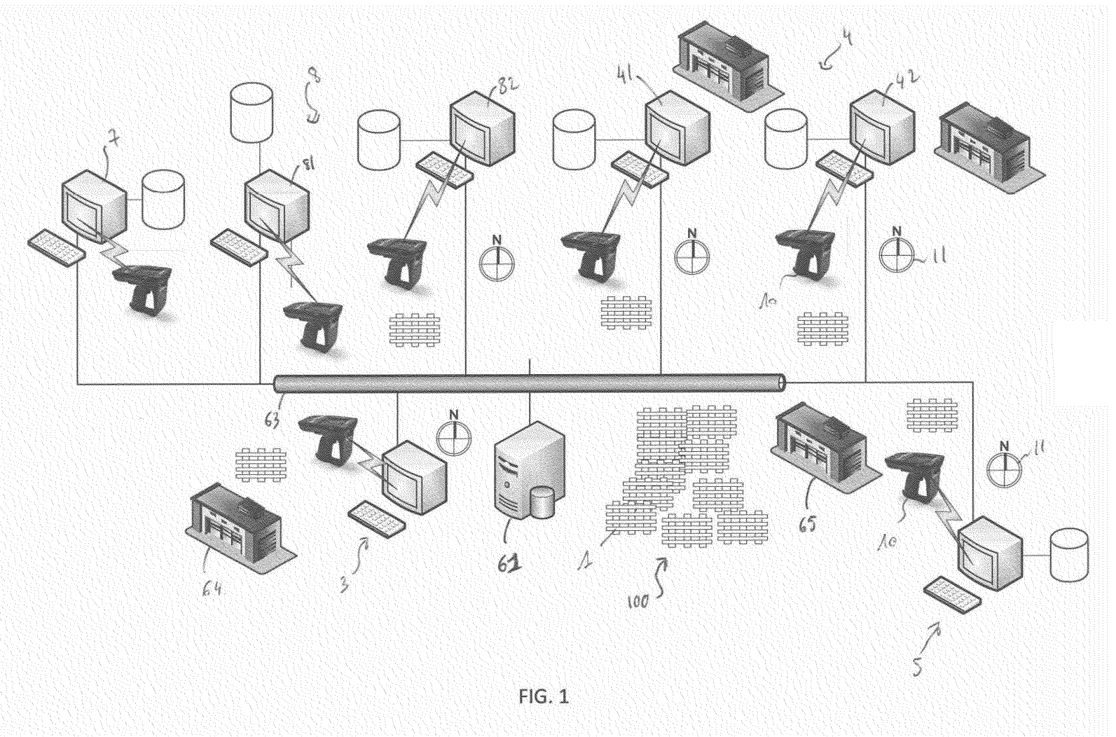

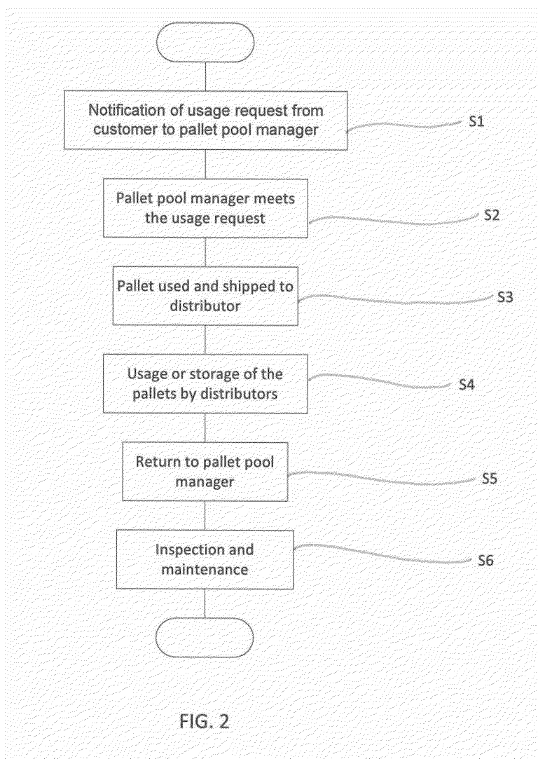

As illustrated by FIGS. 1 and 2, a pooled pallet system 6 for managing a pool 100 comprising a plurality of pallets 1 operates as follows:

(S1) a customer 5 notifies a pallet pool manager 3 of an usage request (such as a rental order) for some of the pallets 1 of the pool 100, e.g., for a required shipment of products;

(S2) the pool manager 3 ships ready-for-use, e.g., plastic coated wooden, pallets 1 to the facility of the customer 5 in truckload quantities, in order to meet the request;

(S3) the customer 5 palletizes its products onto the pallets and ships them down a distributor network (not shown);

(S4) distributors of the distributor network (not shown) receive the palletized products and either store the products in warehouses or use the pallets to move the products to retailers (not shown). Once the pallets have been emptied at a retail outlet (not shown), the distributor relocates the pallets to distribution centers, e.g., to the facility of the customer 5;

(S5) pallets 1 are accumulated at the distribution center and the customer 5 returns the pallets 1 to the pool manager 3; and

(S6) the pool manager 3 inspects the pallets and prepares the pallets for another shipment.

Since the pallets are owned by pallet owners and rented via the pool manager to customers, and since the pallet owner may or may not be also the pool manager, it is important (both for pallet owners, for asset tracking purposes, as well as for customers, for billing purposes) for the pallet pool manager 3 (which deals with the rental sales contracts, the pool management and the invoicing and account) to know the current location of the pallets 1 as well as the location history of the pallets. The method described herein may thus use a tracking method and system for tracking the pallets. An example of a tracking method is described in PCT/US2009/063170, entitled “System and method for tracking distribution of items” and filed on 3 Nov. 2009, the disclosure of which is herein incorporated by reference.

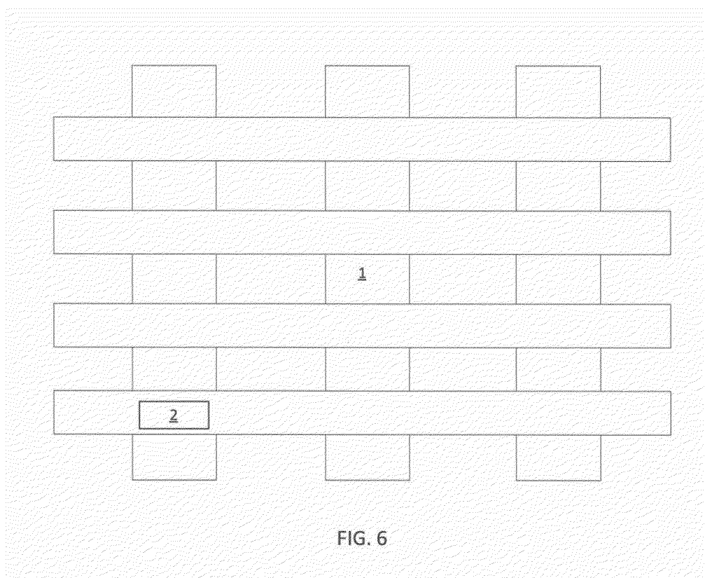

As shown in FIGS. 1 and 6, in a method described herein, each item 1 e.g., a pallet 1 is embedded with or includes an identification tag 2, e.g., RFID tags, optically scannable, e.g., bar-coded, tags, etc., which carry, e.g., electronically- or optically-stored, identification information.

Pallet 1 may be made of any suitable material, e.g., wood, polystyrene, cardboard, plastic coated wood, polystyrene, or cardboard or plastic. Plastic coated wooden, polystyrene, or cardboard pallets and plastic pallets, as compared to traditional, uncoated, e.g., wooden pallets, are sturdier, readily washable and more easily maintained, so that the useful life of the pallets may be greatly increased. In addition, plastic keeps the identification tags well preserved and protected from damage.

When the items 1 arrive at a location, such as a depot location or a retailer location, an operator at the location uses a scanning device, such as an RFID reader 10 or optically scanner 10, to obtain the information that is stored in the identification tags 2 from the tags to a database 61, e.g., which, at least partially, may be part of a tracking system 6. The information is thus accessible to the pool manager 3. This electronically stored information may include identification information for the item 1 or may include any other information, such as a shipment history for the item 1.

Each scanning location can be identified by scanning location information 11. When an item 1 is scanned at a location, the scanned information is used to identify the item to the database 61. The database 61 stores the scanning location information 11 into a shipment history for the scanned item 1. This process is repeated at every scanning location to which the item 1 is sent. As a result, when an item 1 is scanned at a scanning location, the previous shipment history is available to the operator via the database 61. The operator may view the shipping information on a terminal 3, 4, 5, 6, 7 or 8, comprising electronic user interface, monitor or any other display device. Once scanned, the item 1 may then be stored in a temporary storage location, the temporary storage location information also being maintained in the database 61. The items 1 may be grouped, at the temporary storage location, into so-called containers to simplify management of the items 1. The container may correspond to a physical container, e.g., a shipping container, or a physical location at a depot, e.g., a specific location on the floor of a warehouse (such as a warehouse 64 or 65 of the manager 3), or the container may correspond to a logical container.

Once it is determined that an item 1 is to be sent to another location, an outbound procedure, which may or may not include a second scanning operation, is followed. In embodiments, using an interface device for display and input of information, an operator can select an item, a group of items, or a container of items, and indicate, through the interface, where the selected item or items should be sent. Once the future location is selected, the items may be sent to the future location without an additional, e.g., outgoing, scan. The outbound scanning information may thus not be necessary to the procedure, as the database 61 may be updated based on the information input by the operator. Once the items reach the future location, they may be scanned upon arrival at the future or next location, e.g., an incoming scan, and the process may be repeated.

As illustrated in FIGS. 1, 3, 4 and 5, in embodiments the system 6 is configured to provide management of the common pool 100 of pallets 1 from multiple owners, i.e. the pallets 1 of the pool 100 are not owned by a single owner, but some pallets 1 of the pool 100 are owned by one owner, and some other pallets of the pool 100 are owned by another owner, etc. The owners may be referred to introducers in the specification.

In embodiments, the system 6 mainly comprises the terminal 3 of the manager of the common pool 100 and the database 61 configured to store information including an index of all items 1 to be tracked, the identification information of each item 1 and the item location identifiable by scanning the location information 11. The system 6 also comprises a communications network 63 connecting the terminal 3 of the manager, the database 61 and the terminals of a plurality of repairers or storage facilities 4. In the specification “repairers or storage facilities” encompasses an authorized coater of the wooden pallets, an authorized repairer of the pallets, or a keeper of the pallets who temporarily stores the pallets. The authorized coaters and repairers of the pallets are authorized to collect pallets for repair, coat wooden pallets and repair pallets for the common pool 100, even if the pallets do not belong to them. Similarly, the keepers of the pallets temporarily collect and store the pallets when, e.g., storage of the pool manager is full or is not necessary.

The system 6 is configured to enable data flow in the network 63. The data flow may correspond to orders from the customers 5 to the manager 3 and may correspond to information about a condition of the items 1 (such as a general condition of the item or a usage order for the item).

In embodiments, the system 6 may further be configured to enable distribution of a pallet of the common pool 100. As described below, in embodiments the distribution of the pallet is performed as a function of the data flow and the locations of the pallets 1. In embodiments, distribution of the pallets is performed regardless of ownership of the pallets, which may include identification of a proximate operator for an activity selected from the group consisting of: manufacture; a repair; storage; a combination thereof. In embodiments, a distance travelled by the pallet 1 to reach a repairer or storage facility 4 in order to meet a predetermined level corresponding to a satisfactory condition of the pallet 1, may be optimized. A satisfactory condition may be a condition which enables the pallet to be rented to a customer 5. Optimization may include minimization of the distance travelled or reach of a predetermined threshold (i.e. the pallet may be sent when it is determined that the distance to travel is below a threshold corresponding to an acceptable or cheap distance, even if it is not the shortest distance possible), thereby decreasing fuel consumption and release of greenhouse effect exhausts in the atmosphere.

Since both the location information of a pallet 1 and the information regarding the condition of the pallet 1 are known to the manager 3, in embodiments a pallet 1 which is not in a satisfactory condition and needs repair may be sent to a repairer or storage facility such that the distance travelled by the pallet 1 to reach the repairer or storage facility is minimized or is below a predetermined threshold. The entity 4 may indeed comprise repairers or storage facilities 41 and 42, and a pallet 1 for example from the warehouse 65 of the manager 3 may be sent to the repairer or storage facility 42, rather than to the repairer or storage facility 41, because the distance from the warehouse 65 to the repairer or storage facility 42 is shorter than the distance from the warehouse 65 to the repairer or storage facility 41.

Alternatively or additionally, a pallet 1 which is in a satisfactory condition but is not needed by the manager 3 for rent (e.g., off-peak season) may be sent to a repairer or storage facility 4 for storage, such that the distance travelled by the pallet 1 to reach the repairer or storage facility is minimized or is below a predetermined threshold. For example a pallet 1 from the warehouse 64 of the manager 3 may be sent to the repairer or storage facility 41, rather than to the repairer or storage facility 42, because the distance from the warehouse 64 to the repairer or storage facility 41 is shorter than the distance from the warehouse 64 to the repairer or storage facility 42.

As it is appreciated, ownership of the pallets either by the manager 3 or the repairer or storage facility 4 is not required for managing the pool 100. The fact that ownership is not required has the further advantage that efficient management of the pool is enhanced, with optimization of the distances travelled by empty pallets to reach the repairer or storage facility.

In other embodiments, the network 63 further connects to the terminals 5 of at least one customer for the pallets 1. In embodiments the system 6 may thus be further configured to enable distribution of the pallets such that a distance, travelled by the pallet 1 to reach a customer 5 in order to meet a usage request from the customer 5, is optimized.

Alternatively or additionally, a pallet 1 which is in a satisfactory condition may be sent to a client 5 such that the distance travelled by the pallet 1 to reach the customer is minimized or is below a predetermined threshold. A pallet from the warehouse 65 may be sent to the costumer 5, rather than a pallet from e.g., the warehouse 64, because the distance from the warehouse 65 to the costumer 5 is shorter than distance from the warehouse 64 to the costumer 5.

In embodiments, the communications network 63 may further connect the terminal 3 of the manager to at least one terminal 8 of a manufacturer. In the specification “manufacturer” encompasses an authorized manufacturer of the pallets, which may require coating of e.g., wooden pallets. The authorized manufacturers of the pallets (such as wooden pallets, plastic coated wooden pallets, or plastic pallets) are authorized to manufacture and deliver pallets for the pool 100. During manufacture, an identification tag 2 is attached or embedded to the pallet. Once manufactured, the pallets belong to the manufacturer or are assigned to an owner. If the owner wishes the manufactured pallet to be part of the pool 100, registration of the pallet to the manager 3 is performed.

In embodiments, the system 6 may be configured to provide a data processing system configured to provide distributed management of the pool 100 of pallets 1 from the pallet introducers (i.e. owners). The system 6 comprises an input interface for receiving data relating to the identification tag read at a plurality of locations. The database 61 is adapted to store, for each pallet 1 of the pool 100 of pallets, a record comprising data read from the identification tag, tracking data identifying the location of the pallet, pallet activity data and pallet introducer data. The system 6 also comprises logic to monitor events relating to a pallet for actionable or chargeable events and logic to credit an account related to the introducer of a pallet for a chargeable event. The system 6 also comprises an interface for receiving identifiers of pallets introduced by the introducer. This is performed during registration. The database 61 may further be adapted to store, for each introducer, an agreed tariff for introducing a pallet in the pool. The introducer may thus be credited for introducing pallets in the pool 100.

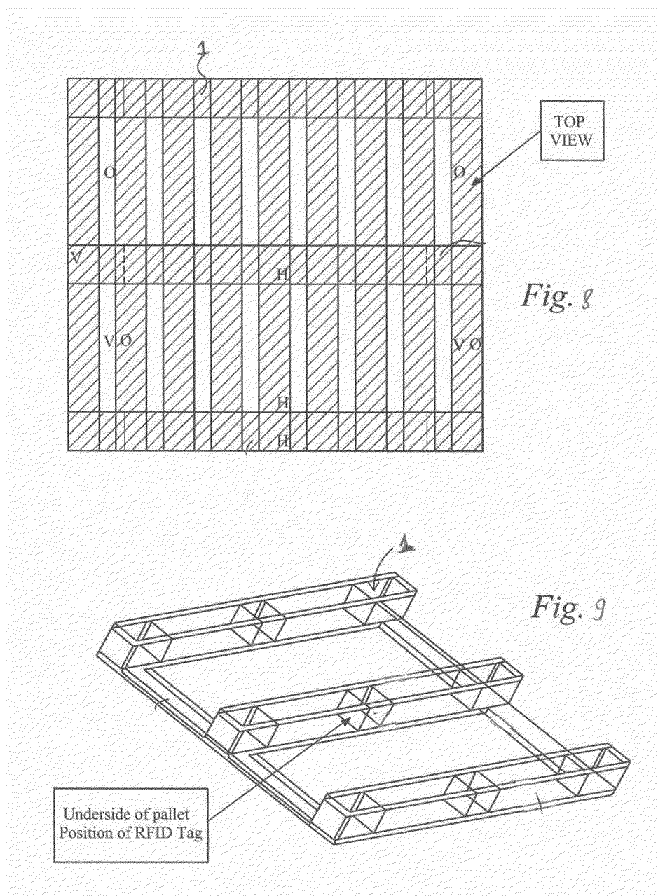

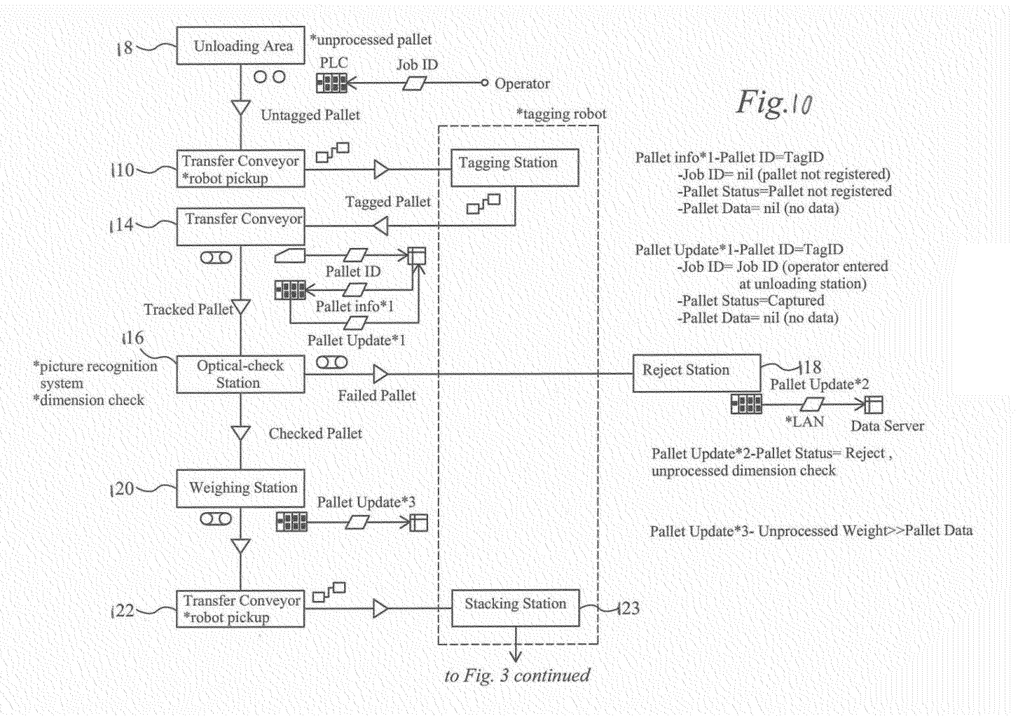

Referring to FIGS. 8 and 9, a wooden pallet 1 comprises three legs or stringers, which comprise parallel spaced wooden batons. To the upper surfaces of these are attached a plurality of thinner wooden strips forming the top deck or load surface of the pallet 1. The strips are placed close together and extend across the pallet perpendicular to the legs. For simplicity, only the edge strips are shown in FIG. 9. It will be appreciated that reference to the wood material of the pallet may include wooden products such as compressed wood or chipboard, etc.

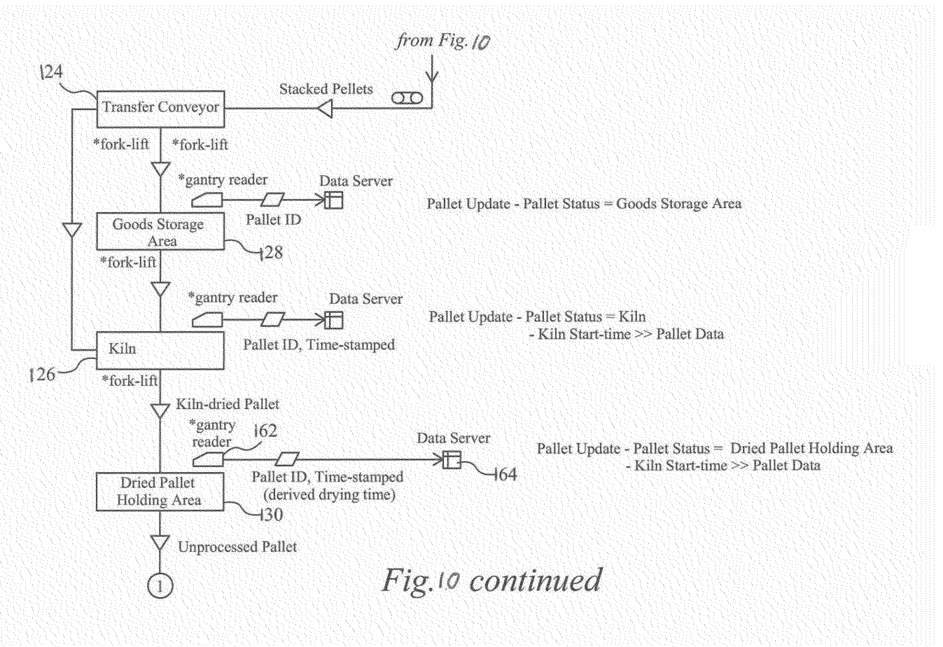

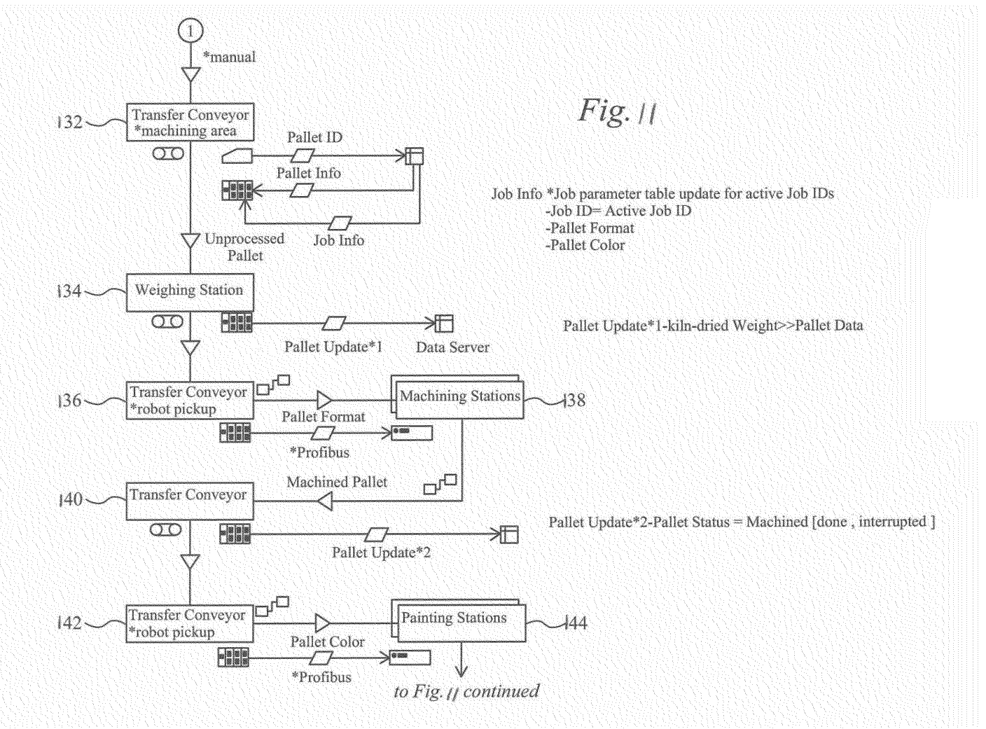

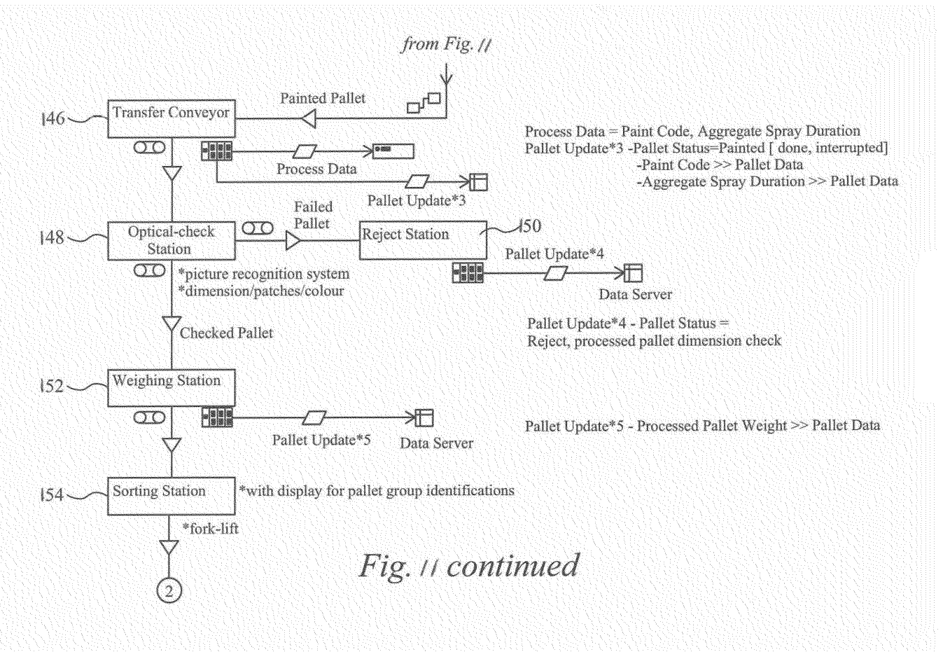

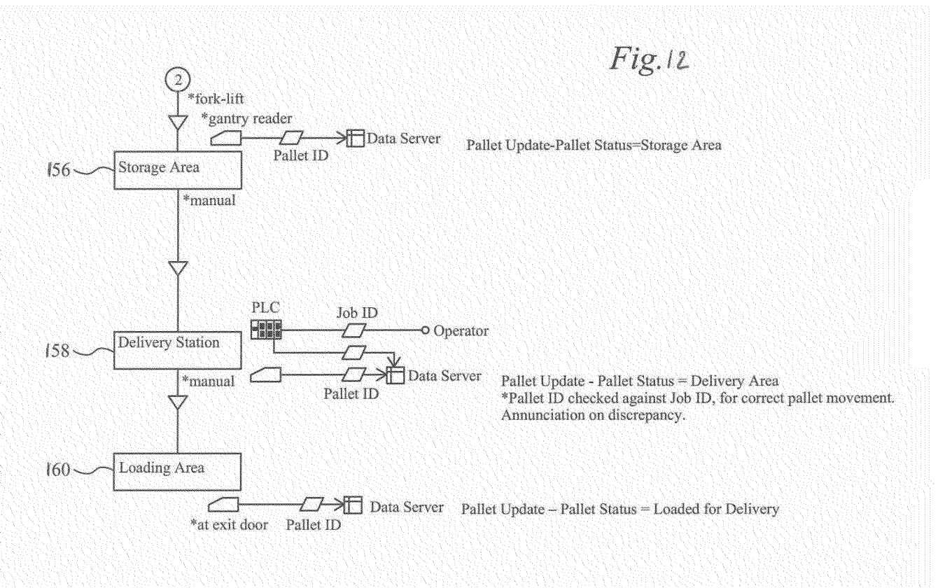

Referring also to FIGS. 10, 11, and 12, which show an example of a process according to the disclosure, wooden pallets for processing may be delivered to an unloading area 118. The pallets are conveyed by a first transfer conveyor 110, and are picked up one at a time by a robot on a load cell section for weighing each pallet. The robot then offers each pallet to a tagging station 112 where an RFID tag is stapled to the pallet, for example using a plastic staple, on a side face 111 of a centre leg of the pallet. The tag may include information such as a pallet identification code, a job identification code, and other data relevant to the pallet. The pallet is transferred from the tagging station to a further conveyor 114 and to an optical checking station 116. An optical check comprises inspecting the pallet with a product recognition camera to check the pallet size/type and that it is within dimensional tolerances for the process. At this stage a failed pallet is rejected and conveyed to a reject station 118 for manual checking A pallet which has passed the check is conveyed to a weighing station 120 where the weight of the pallet is logged. A further transfer conveyor 122 takes the pallet to a stacking station 123 where it is stacked by a robot on a gravity conveyor 124. The stacked pallets may then be transferred by forklift to a kiln 126, via a storage area 128. The pallets are dried in the kiln according to requirement. Moisture and temperature sensors are used to dry the pallets until they have a moisture content of about 8 to 10% by weight. The kiln dried pallets are then unloaded by forklift onto a gravity roller conveyor 132 via a holding area 130, to a second weighing station 134 which may comprise a load cell in the final section of the conveyor. The pallet is then transferred via a conveyor 136 to a machining station 138. A robot picks up each pallet and places four pallets on the bed of a router where vacuum grippers hold them in place. The router reads the tag to identify the type of pallet and then machines the pallet on all faces to a set tolerance in accordance with the information obtained. The robot then turns over the pallets and the process is repeated on the other side. The router is programmed to ensure it does not machine the area where the tag is positioned. The pallets are transferred from the machining station via another conveyor 140. A robot removes the pallets and places them individually vertically on a powered conveyor 142 with the underside facing spray bays of painting stations 144. The pallets travel along the conveyor and into holding station in front of each spray bay. A robot with a polyurethane spraying head sprays the centre leg first and then continues spraying the underside of the pallet. A handling robot then picks up the pallet by gripping the coated centre foot and manipulates the pallet together with the moving spray head to minimize overspray and reduce spraying time. When the pallet is completely coated it is placed face down on a powered conveyor 146. The final 1.2m section is a gravity roller conveyor and mounted on a load cell. At an optical check station 148 a robot picks up the pallet, checks it for size/type and finish using a product recognition camera and reads the RFID tag to identity the customer or pallet maker. If the pallet does not pass the check, it is sent to a reject station 150. Otherwise the pallet is transferred via a further weighing station 152 to a sorting station 154 where a robot stacks the pallet in correct place. The pallets ready for collection by the customer or pallet maker are transferred to a storage area 156, and thence to a delivery station 158 and loading area 160 as required.

As can be seen in the drawings, at each stage of the process, there may be a reader (eg 162) which reads the tag and sends data to a server (eg 164). In this way each pallet can be tracked through the process. Data such as the dimensions and tolerances and drying time for each pallet can also be collected. This data can be used by a computer control system for obtaining process information for controlling the process, for billing and also for quality control purposes.

For example data concerning rejection of pallets, or manual intervention required, for a batch of pallets associated with a customer may be used in deriving the charge to be made to that customer. Also, pallets can be graded according to the data concerning dimensional tolerances.

Previously manufactured pallets may be finished or reconditioned so as to prolong their usable life, or to improve their properties. These methods of finishing or reconditioning may be applied to either wooden or plastic pallets. It has been found that thermosetting plastic coatings, such as polyurethane, may be of particular use in this context.

For example, to recondition a pre-used plastic pallet, the surface of a pallet may be treated so as to facilitate coating of the surface. To facilitate coating the surface energy of the pallet can be increased to improve the wetting characteristics of the pallet. Examples of such surface treatments include corona treatment and flame treatment.

A thermosetting plastic coating comprising a flame retardant may then be applied to the treated surface to recondition it for further use. This enables the reuse of plastic pallets that would otherwise need to be removed from circulation due to safety considerations.

A similar treatment may also be applied to wooden pallets. Surface treatment of wooden pallets can be a particular problem. However, it is possible to use a sand blasting treatment to abrade a surface of the pallet. As will be appreciated in the context of the present disclosure, sand blasting is not a treatment that is usually applied to wood however this treatment is of particular advantage when surface treating wooden pallets to receive a coating.

A thermosetting plastic coating may then be applied to the sand blasted surface of the pallet to provide a water impermeable flame retardant coating to enable the usable life of wooden pallets to be extended and/or to recycle used wooden pallets.

Furthermore, in embodiments the system 6 comprises an interface for a pallet user receiving or dispatching a pallet to upload identifiers of pallets received or dispatched. The chargeable event may then be selected from the group consisting of: use; loss; storage; a combination thereof. An introducer of pallets may then be credited e.g., if some pallets are lost by a customer 5. In preferred embodiments, the system may further comprise logic to credit an account related to the introducer of a pallet based on at least one of an average activity or an aggregate activity of the pallet, e.g., use or rent by the customers 5. In embodiments, an account related to the introducer of a pallet may be credited based on a percentage of an income for the life of the pallet.

Alternatively or additionally, the system may comprise an interface for a transporter of pallets to upload identifiers of pallets in transit; and/or an interface for a storage facility to upload identifiers of pallets for storage. The chargeable event stored in the database 61 may then further comprises at least one of: trip and storage. In embodiments, an account related to the transporter and/or the introducer of a pallet may be credited based on a pallet activity selected from the group consisting of delivery and collection of a pallet, based on the agreed tariff.

Alternatively or additionally, the system may comprise an interface for a maintainer of pallets to upload data relating to a maintenance activity and the chargeable event may further comprise at least one of: repair and storage. In embodiments, an account of a repairer may be credited based for repairing a pallet, based on an agreed tariff.

In embodiments, the system 6 is further configured to identify a need for an order for manufacture of new pallets in order to maintain the number of pallets in the common pool above a predetermined threshold (e.g. a threshold sufficient to meet the rental orders by the customers).

In embodiments, the system 6 is further configured to enable identifying a manufacturer of the pallets such that a distance, travelled by the item to reach the manager in order to maintain the number of items in the common pool above a predetermined threshold, is optimized. Optimization may include minimization of the distance travelled or reach of a predetermined threshold, thereby decreasing fuel consumption and release of greenhouse effect exhausts in the atmosphere. The manufacturers 8 may indeed comprises manufacturers 81 and 82, and an order for a new pallet for the warehouse 64 (because of the location of a specific customer for example) may be sent to the manufacturer 81, rather than the manufacturer 82, because the distance from the manufacturer 81 to the warehouse 64 is shorter than the distance from the manufacturer 82 to the warehouse 64.

In embodiments, the system 6 is configured to provide a unified management of the pool 100 of pallets 1 from multiple owners for rent by the customers 5, each pallet 1 including an identification tag 2 including electronically stored identification information, since the system 6 is configured to identify a need for:

a request for manufacture of a new pallet 1 to replace a missing pallet 1 from the pool 100 or to meet rent requests by the customers 5;

a repair request to repair a pallet 1 no longer satisfactory for rent; and

a storage request to store a pallet 1 no longer required by the manager 3 to meet rent requests by the customers 5.

The manufacturers 8 and the repairer or storage facility 4 may be helped by a production technology adviser 7, which may be connected to the system 6 via the network 63. The adviser 7 may supply to the repairer or storage facility or the manufacturers equipment, raw materials, technical support, training and quality auditing.

Additionally or alternatively in embodiments, the system 6 may be configured to compute information regarding an income from a customer or a payment to a repairer or storage facility, corresponding to the distribution of the pallets. The manager 3 may indeed receive an income from a customer 5 for at least one of the following:

distribution to the customer 5 (including compensation for shipping to a national or international customer);

period spent out with the customer 5 (rental of the pallet income); and

compensation for a pallet lost by the customer 5.

Alternatively or additionally, the manager 3 may indeed make a payment to a repairer or storage facility 4 or a manufacturer 8 for at least one of the following:

coating of a pallet;

storage of a pallet; and

repair of a pallet.

In embodiments, the information stored in the database 61 further comprises indication of ownership of the pallet. In embodiments, the system 6 is further configured to compute information regarding a payment to the owner of the pallet. The payment may be a predetermined amount, a function of a number of pallets of the pool owned by the owner and/or a number of days the owner's pallets are used by customers.

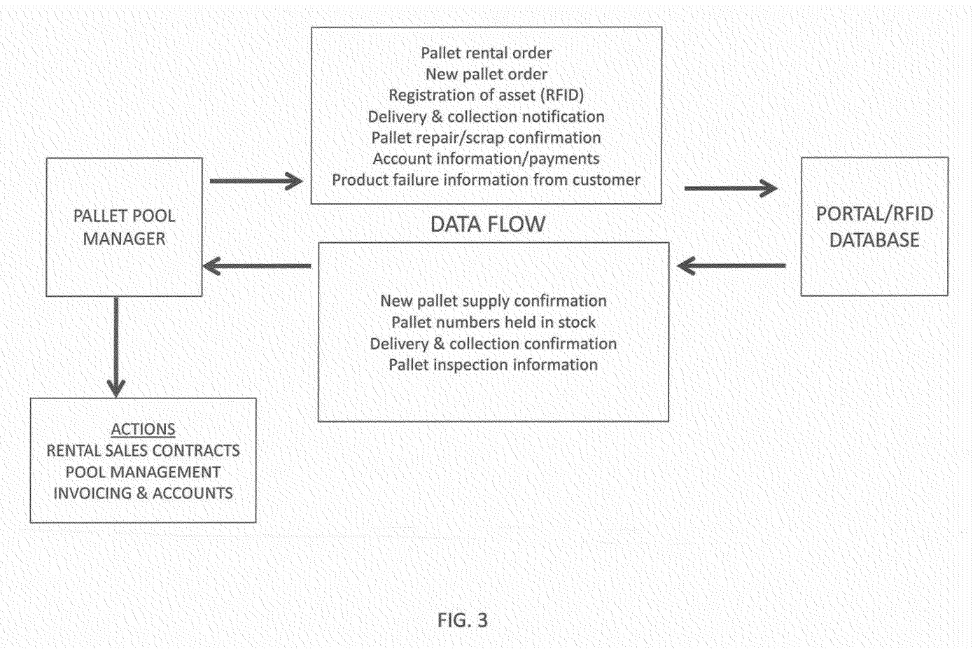

As illustrated by FIG. 3, in order to improve management of the pool 100 of pallets, the data flow between the database 61 and the terminal 3 of the pallet manager may include at least one of the following:

sfrom the terminal 3 to the database 61, for storage:

pallet rental usage requests (i.e. rental order from the customers);

new pallet manufacture order;

registration of a pallet to the pool (i.e. registration of an asset of an owner), using the tag (e.g., RFID);

delivery & collection notification;

pallet repair confirmation;

pallet scrap confirmation;

account information/payments; and

product failure information from customers; and

from the database 61 to the terminal 3, for processing:

new pallet supply confirmation;

pallet numbers held in stock;

delivery & collection confirmation;

pallet inspection information.

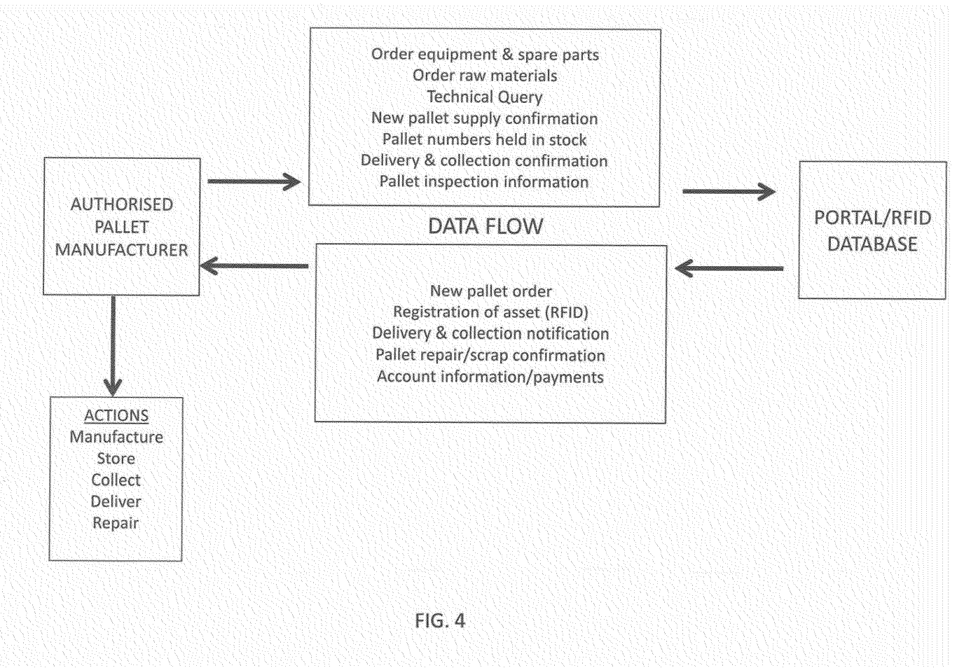

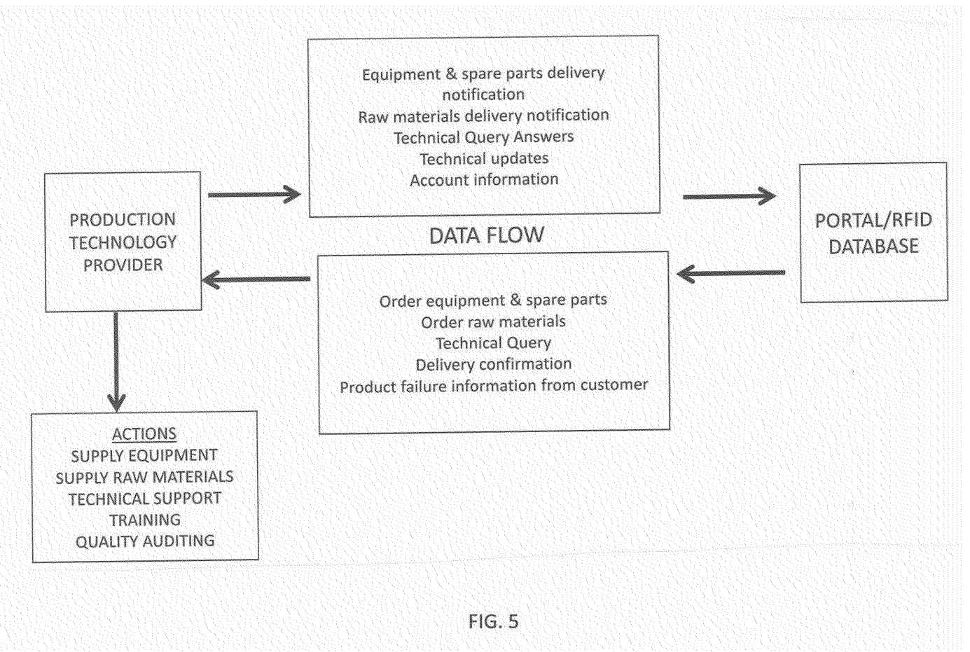

Alternatively or additionally, as illustrated by FIG. 4, the data flow between the database 61 and the terminals 4 or 8 of the repairer or storage facility or manufacturers may include at least one of the following:

from the terminals 4 or 8 to the database 61, for storage:

order equipment & spare parts;

order raw materials;

technical query;

new pallet supply confirmation;

pallet numbers held in stock;

delivery & collection confirmation; and

pallet inspection information; and

from the database 61 to the terminals 4 or 8, for processing:

new pallet order;

registration of asset (RFID);

delivery & collection notification;

pallet repair/scrap confirmation; and

account information/payments.

Alternatively or additionally, as illustrated by FIG. 5, the data flow between the database 61 and the terminal 7 of a production technology provider may include at least one of the following:

from the terminal 7 to the database 61, for storage:

equipment & spare parts delivery notification;

raw materials delivery notification;

technical query answers;

technical updates; and

account information; and

from the database 61 to the terminal 7, for processing:

order equipment & spare parts;

order raw materials;

technical query;

delivery confirmation;

product failure information from customers.

In embodiments, when a pallet 1 needs repair and is sent to a repairer or storage facility 4 or a manufacturer 8, the manager 3 may send to the corresponding repairer or storage facility 4 or manufacturer 8, via the database 61, a delivery notification and account information for payments of the repair. The corresponding repairer or storage facility 4 or manufacturer 8 may send to the manager 3 collection confirmation and pallet inspection information. In embodiments, the corresponding repairer or storage facility 4 or manufacturer 8 may send to the production technology provider 7 orders for equipment and spare parts, order for raw materials, technical queries, and product failure information from customers. The production technology provider 7 may provide what is needed and may reply by equipment and spare parts delivery notifications, raw materials delivery notifications, technical query answers, technical updates, and account information for invoicing. The corresponding repairer or storage facility 4 or manufacturer 8 may send to the manager 3 pallet repair confirmation when the pallet is repaired.

In embodiments, when a pallet 1 needs to be manufactured and an order is sent to a manufacturer 8, the manager 3 may send to the corresponding manufacturer 8, via the database 61, a new pallet manufacture order. In embodiments, the corresponding manufacturer 8 may send to the production technology provider 7 orders for equipment and spare parts, order for raw materials, and technical queries. The production technology provider 7 provide what is needed and may reply by equipment and spare parts delivery notifications, raw materials delivery notifications, technical query answers, technical updates, and account information for invoicing. The manufacturer 8 may then send to the manager 3 a new pallet supply confirmation when the pallet is manufactured, and the manager 3 may reply by a registration of the pallet to the pool (i.e. registration of an asset of an owner), using the tag (e.g., RFID) and a collection notification to the manufacturer when the pallet is collected and registered to the pool 100.

In embodiments, if a repairer or storage facility 4 determines that the pallet should be sent to scrap, he indicates so in the pallet inspection information, and in response the manager 3 may issue a scrap confirmation. The manager 3 may decide to order a new pallet to replace the pallet for scrap, if necessary.

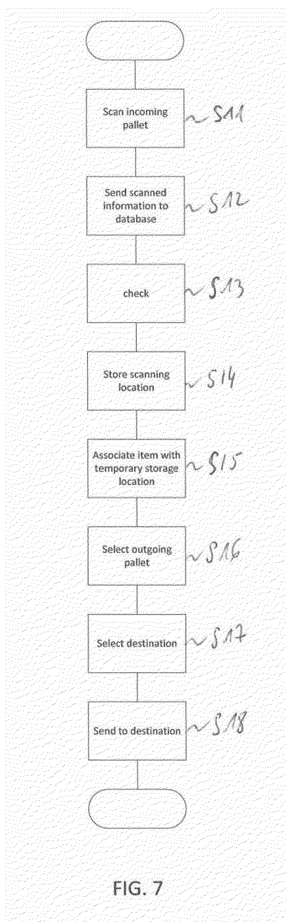

FIG. 7 is a flow diagram of a method of tracking which may be used in an example embodiment in accordance with the present disclosure. In S11, the incoming pallets 1 are scanned using a reader 10, e.g., an RFID reader, an optical scanner, etc. The scanned information may include identification information, for identifying the particular pallet, or a pallet as part of a particular grouping of pallets, such as a container. In S12, the scanned information is sent to the database 63. The database 63 includes an index of all of the pallets 1 that are in circulation in the pool 100 of pallets 1 being tracked. The scanned pallet identification information is checked against the database 63, in S13, so as to identify the particular pallet or container of pallets being scanned. In S14, scanning location information is stored in the database 63. Scanning location information may include information identifying the scanning location 11. This scanning location information is stored in the database 63 such that it is associated with the pallet or pallets identified in S13. This scanning location information may include information identifying the type of scanning location, for example, as a retail location or a depot location. This stored scanning location information serves as a shipping history for the associated pallet or pallets. If the stored scanning location information includes the date and/or time of the incoming scan, it is also possible to track the duration of stay for each pallet at a given scanning location, e.g., for auditing, billing, accounting purposes, etc. The type of location and the duration of stay may be used, for example, by an operator or other user trying to determine the nature or length of the pallet's stay at a location, how the pallet was used at a location, etc.

A transaction may be classified according to the most recent scanning location information and the duration of stay. For example, a transaction may be classified as a return if the pallet is being sent from a retail location to a depot location, or a transfer if the pallet is being sent from one depot location to another, or from one retail location to another. Further, a pallet need not be sent to a depot location between shipments to retail locations. It is possible, to transfer pallets from one retail location to another. In this manner, greater efficiency of the pallet network may be attained.

Each pallet, in S15, is associated with a temporary storage location until the pallet is assigned to a destination location. This temporary location may by the floor of a warehouse or particular location of the floor of the warehouse, a trailer for storage, a container, or any other location where the pallet may be found when it is requested to be moved. In S16, when a pallet or container of pallets is requested to be shipped to a destination location, the operator can select a pallet or container of pallets using an interface. The interface may include data input devices, such as a keyboard or a mouse, along with a display. The operator, in S17, may select a destination location for the pallet or container of pallets, optionally without performing a subsequent, or outgoing, scan of the pallet or container of pallets. In S18, the destination location information is stored in the database 63, associated with the pallet or container of pallets, and the pallet or pallets are then sent to the destination location, optionally without performing a subsequent, or outgoing, scan of the pallet or pallets.

At the destination location, the process is started again at the scanning of incoming pallets at the destination location.

The method described herein may be used in connection with wood, plastic coated wood or plastic pallets, such pallets being often shipped to many locations, and perhaps carry a wide variety of products or other items. However, it should be understood that the system and method described herein may be used in connection with any other item.

What is claimed is:

1. A data processing system configured to provide distributed management of a pool of pallets from pallet introducers, each pallet including an identification tag including electronically stored identification information, the system comprising:
an input interface for receiving data relating to an identification tag read at a plurality of locations;
a database adapted to store, for each pallet of the pool of pallets, a record comprising data read from the identification tag, tracking data identifying the location of the pallet, pallet activity data and pallet introducer data;
an interface for receiving identifiers of pallets introduced by an introducer;
an interface for a pallet user receiving or dispatching a pallet to upload identifiers of pallets received or dispatched;
logic to monitor events relating to a pallet for actionable or chargeable events;
logic to credit an account related to the introducer of a pallet for a chargeable event.

2. The system of claim 1, wherein the chargeable event is selected from the group consisting of:
use; loss; storage; a combination thereof

3. The system of claim 1, further comprising:
an interface for a transporter of pallets to upload identifiers of pallets in transit; and
logic to credit an account related to the transporter of the pallet for a chargeable event, the chargeable event further comprising a trip.

4. The system of claim 1, further comprising:
an interface for a storage facility to upload identifiers of pallets for storage; and
logic to credit an account related to the storage facility for a chargeable event, the chargeable event further comprising storage.

5. The system of claim 1, further comprising:
an interface for a maintainer of pallets to upload data relating to a maintenance activity; and
logic to credit an account related to the maintainer for a chargeable event, the chargeable event further comprises at least one of: repair and storage.

6. The system of claim 1, wherein the database is further adapted to store, for each introducer, an agreed tariff for chargeable events.

7. The system of claim 1, further comprising logic to credit an account related to the introducer of a pallet based on at least one of an average activity or an aggregate activity of pallets in the pallet pool.

8. The system of claim 1, further comprising logic to credit an account related to the introducer of a pallet based on a predetermined proportion of an income generated by the pallet over a predetermined time interval.

9. The system of claim 1, wherein the information stored in the database further comprises information selected from the group consisting of: pallet rental order; new pallet manufacture order; equipment and spare parts order; equipment and spare parts delivery confirmation; raw material order; raw material delivery confirmation; new pallet supply confirmation; registration of pallet to the common pool; number of pallets in stock; pallet delivery notification; pallet collection notification; pallet repair confirmation; pallet general condition information; confirmation of pallet for scrap; income from pallet customer; payment to pallet activity operator; information feedback; technical query; technical response; a combination thereof

10. The system of claim 1, wherein the pallet is selected from the group consisting of: a plastic pallet, a wooden pallet, a cardboard pallet, a polystyrene pallet, and a plastic coated pallet selected from the group consisting of wooden; cardboard; polystyrene pallet.

11. A method comprising:
providing an input interface for receiving data relating to an identification tag including electronically stored identification information read at a plurality of locations, the identification tag being included in a pallet of a pool of pallets from pallet introducers;
storing in a database, for each pallet of the pool of pallets, a record comprising data read from the identification tag, tracking data identifying the location of the pallet, pallet activity data and pallet introducer data;
providing an interface for receiving identifiers of pallets introduced by an introducer;
providing an interface for a pallet user receiving or dispatching a pallet to upload identifiers of pallets received or dispatched;
monitoring events relating to a pallet for actionable or chargeable events;
crediting an account related to the introducer of a pallet for a chargeable event.

12. The method of claim 11, wherein the chargeable event is selected from the group consisting of: use; loss; storage; a combination thereof

13. The method of claim 11, further comprising:
providing an interface for a transporter of pallets to upload identifiers of pallets in transit; and
crediting an account related to the transporter of the pallet for a chargeable event, and
wherein the chargeable event further comprises at least one of: trip and storage.

14. The method of claim 11, further comprising:
providing an interface for a maintainer of pallets to upload data relating to a maintenance activity; and
crediting an account related to the maintainer for a chargeable event, and
wherein the chargeable event further comprises at least one of: repair and storage.

15. The method of claim 11, further comprising storing, for each introducer, an agreed tariff for chargeable events.

16. The method of claim 11, further comprising crediting an account related to the introducer of a pallet based on at least one of an average activity or an aggregate activity of pallets in the pool.

17. The method of claim 11, further comprising crediting an account related to the introducer of a pallet based on a predetermined proportion of an income generated by the pallet over a predetermined time interval.

18. A method comprising:
identifying pallets of a pool, each pallet including an identification tag including electronically stored identification information; and
storing, for each pallet of the pool of pallets, a record comprising data read from the identification tag, tracking data identifying the location of the pallet, pallet activity data and pallet introducer data; and
storing financial information data based on the data comprised in the record and enabling distribution of funds between operators based on the activity of the pallet.

19. The method of claim 18, further comprising determining a shipment history of the pallets as a function of at least one of (a) previously read information and (b) previous location information previously stored in a database.

20. The method of claim 18, further comprise classifying a transaction as one of (a) a return and (b) a transfer based on at least one of (a) a most recent location in the shipping history and (b) a duration of time between successive reads of the pallet.
